(19) United States
(12) Patent Application Publication
(10) Pub. No.: US 2004/0129860 A1
(43) Pub. Date: Jul. 8, 2004

(54) Lighting device and use thereof

(75) Inventors: Philippe Thibaud, Orleans (FR); Jerome Monnot, Menestreau En Villette (FR); Sebastien Bouillhol, St Remy Les Chevreuses (FR); Yves Fichot, Orleans (FR)

Correspondence Address: YOUNG & THOMPSON, 745 SOUTH 23RD STREET 2ND FLOOR, ARLINGTON, VA, 22202

(73) Assignee: ALM, ARDON (FR)

(21) Appl. No.: 10/740,552

(22) Filed: Dec. 22, 2003

(30) Foreign Application Priority Data
Dec. 24, 2002 (FR) 02 16676

(51) Int. Cl. G01J 1/32

(52) U.S. Cl. 250/205

(57) ABSTRACT

The lighting device for lighting a lighted field comprises a light source having first and second lighting modules. The lighting modules are adapted to light lighted domains of the lighted field. The lighted domains form an overlap zone, and each lighting module defines an overlap volume. The device includes detector means adapted to detect a zone of reduced lighting in the overlap zone, and control means adapted to increase the light flux from said second lighting module when the detector means detect a zone of reduced lighting. The invention is applicable to lighting devices used in operating theaters.

The present invention relates to a lighting device for lighting a lighted field, in particular an operative field for a doctor, the device being of the type comprising a light source with first and second lighting modules, the lighting modules being adapted to light respective first and second lighted domains of the lighted field, said lighted domains overlapping at least in part so as to form an overlap zone, and each lighting module defining an overlap volume extending between the overlap zone and the surface of the light-emitting module that emits light towards the overlap zone.

It applies in particular to devices for lighting operative fields in surgical operating theaters.

### BACKGROUND OF THE INVENTION

Lighting devices in operating theaters are known. Such devices comprise a light source whose light beam is directed towards the operative field.

When an obstacle, such as a surgeon's head, intercepts the path of light from the light source to the lighted field, a shadow is cast, thereby reducing the quality of the lighting, which is not very ergonomic.

### OBJECTS AND SUMMARY OF THE INVENTION

An object of the present invention is to mitigate that drawback and to propose a lighting device that is more ergonomic.

To this end, the invention provides a device of the above-specified type, including detector means adapted to detect a zone of reduced lighting in the overlap zone; and control means adapted to increase the light flux from said second lighting module when the detector means detect a zone of reduced lighting.

In other embodiments, the invention includes one or more of the following characteristics:

the light source is adapted to light the overlap zone with a determined level of lightning, and the control means are adapted to increase the light flux from said second lighting module in such a manner that the level of lighting in the overlap zone is equal to the determined level;

the detector means are adapted to detect a shadow zone which is created by an obstacle in the overlap volume of said first lighting module and which is situated at least in part within the overlap zone, the control means are adapted to increase the light flux from said second lighting module by a determined ratio, and the determined ratio is equal to the ratio of the area of the shadow zone to the area of the overlap zone;

the control means comprise means for decreasing light, and adapted to decrease the light flux from said first lighting module when said detector means detect a zone of reduced lighting;

said first and second lighting modules are each adapted to emit light having identical spectral composition;

at least one of the lighting modules comprises a light emitting diode;

at least one of the lighting modules comprises a plurality of light-emitting diodes with at least two of the light-emitting diodes being adapted to emit light of different colors, and the control means comprise a control unit associated with each lighting module, said control unit being adapted to adjust the individual light flux level emitted by each of the light-emitting diodes of the lighting module as a function of a given reference value representing a color and an intensity;

the light source comprises a plurality of lighting modules each comprising a plurality of light-emitting diodes, the control means comprise a central unit adapted to generate individual reference values representing a color and an intensity of light for each of the lighting modules, and each control unit is connected to the central unit so as to be able to receive the reference values for color and intensity;

at least one lighting module comprises detector means for detecting a defective light-emitting diode, and the device further comprises means for compensating the defect of a defective light-emitting diode;

the compensation means comprise means adapted to decrease the light flux from the light-emitting diode emitting light of a color other than the color of the defective light-emitting diode;

the lighting module comprises at least one other light-emitting diode of a color identical to that of the defective light-emitting diode, and the compensation means are adapted to increase the light flux from the light-emitting diode having the same color as the defective light-emitting diode; and

the color rendering index of the light source is at least 90.

The invention also provides the use of a device as specified above to light a field in which a doctor is taking action.

### BRIEF DESCRIPTION OF THE DRAWINGS

The invention will be better understood on reading the following description given purely by way of example and made with reference to the accompanying drawings, in which:

FIG. 1 is a diagrammatic side view of the lighting installation of the invention;

FIG. 2 is a view of a set of lighting elements seen looking along II-II in FIG. 1;

FIG. 3 is a view of a lighting element of the invention; and

FIG. 4 is a view of a portion of the lighted field seen looking along IV-IV of FIG. 1.

### MORE DETAILED DESCRIPTION

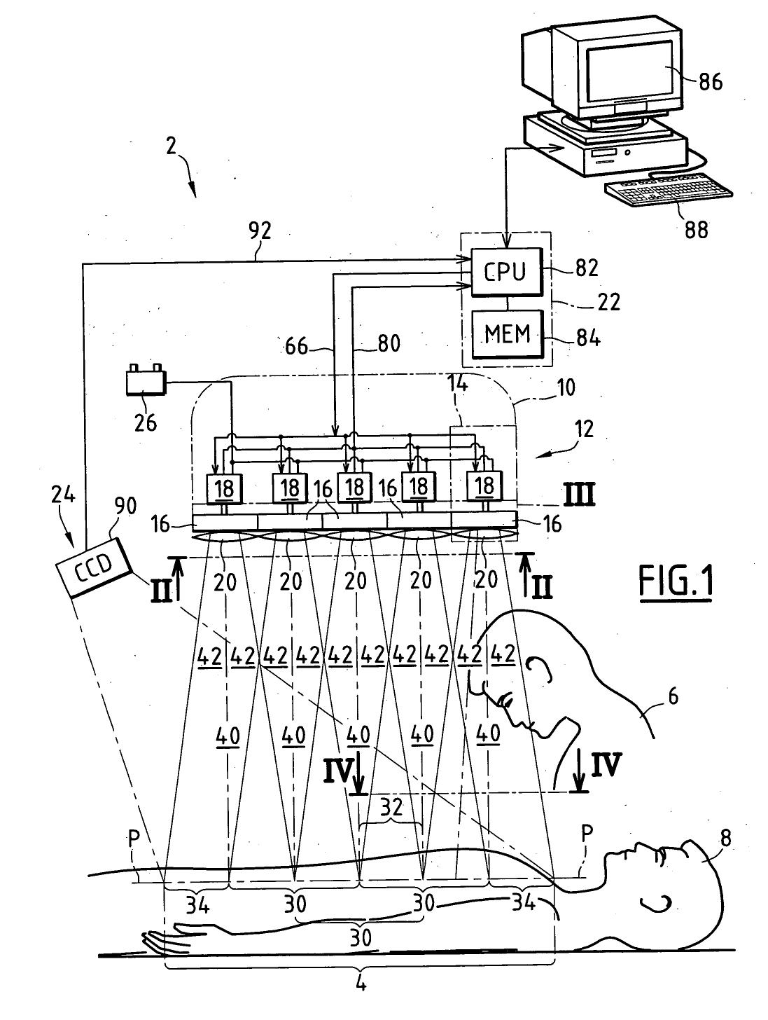

FIG. 1 shows a lighting installation of the invention, given overall reference 2.

The installation is designed to light a lighted field 4 extending in a horizontal lighted plane P-P. Specifically, the lighted field 4 is the field in which a doctor 6 is taking action on a patient 8 in an operating theater.

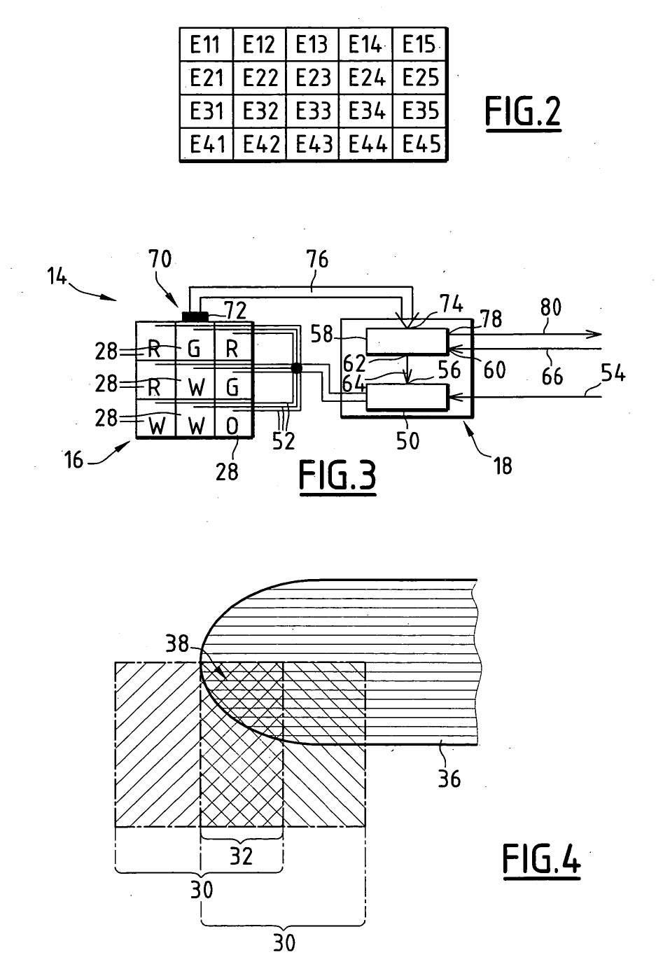

The installation 2 comprises a housing 10 containing a light source 12 constituted by a plurality of lighting elements 14. In the present case, the installation 12 comprises a matrix of twenty lighting elements 14 arranged in five columns of four rows each, as shown in FIG. 2. The five lighting elements 14 in the first row can be seen in FIG. 1.

Each lighting element 14 comprises a lighting module 16, a control unit 18 associated with the lighting module 16, and optical elements 20.

The installation 2 also comprises a central unit 22, means 24 for detecting an obstacle, and a source 26 of electricity.

As shown in FIG. 3, each lighting module 16 comprises nine light-emitting diodes (LEDs) 28 disposed in a 3×3 matrix. The lighting modules 16 are disposed in a plane E-E parallel to the plane P-P. The light emission direction of each LED is perpendicular to the plane E-E. Each lighting module 16 comprises at least a red LED (R), a green LED (G), an orange LED (O), and also a white LED (W). In the example shown, each lighting module 16 comprises three red LEDs 28, two green LEDs 28, one orange LED 28, and three white LEDs 28. The red LED to green LED to orange LED to white LED ratio is thus 3:2:1:3.

The emission spectrum maximum of each of the LEDs 28 preferably lies in one of the following ranges:

red LED: 645 nanometers (nm) to 660 nm

green LED: 513 nm to 528 nm

orange LED: 592 nm to 597 nm

white LED: 460 nm to 470 nm.

The lighting modules 16 are preferably all identical. The LEDs 28 of the lighting module are selected so that the color rendering index (CRI) of a lighting module 16 is greater than 90, thus ensuring that the colors of patient tissue are represented in a manner that is close to reality.

Each lighting module is adapted to light a determined lighted domain 30, situated within the lighted field 4 and which is constituted by a portion of the area of the lighted field 4.

The lighting modules 16 are arranged in such a manner that the lighted domains 30 of two adjacent lighting modules 16 overlap in part so as to form an overlap zone 32 (see FIG. 4). Two adjacent lighted domains 30 overlap over half their respective areas, such that each location in the lighted field 14 receives light from two lighting modules 16, with the exception of a marginal zone 34 of the lighted field which has a width of half the dimensions of a lighted domain 30 (see FIG. 1).

By way of example, FIG. 4 shows the lighted domains 30 of two lighting modules 16 forming an overlap zone 32.

FIG. 4 also shows a shadow domain 36 created by the head of the doctor 6. The shadow domain 36 extends into the overlap zone 32, forming therein a shadow zone 38.

Each lighting module 16 is adapted to emit a volume of light 40 (see FIG. 1) and specifically in this case a truncated pyramid of light, extending between the light-emitting surface of the lighting module 16 that is emitting the light towards the lighted domain, and the corresponding lighted domain 30. Each light volume 40 also defines at least one overlap volume 42 extending between the light-emitting surface of the lighting module 16 which emits the light towards the overlap zone and the corresponding overlap zone 32.

The optical elements 20 are disposed on the path of the light rays from each lighting module 16. By way of example, these optical elements 20 are lenses and they are adapted to focus the emitted light towards the lighted plane P-P, so that the light emitted by each lighting module 16 has a uniform spectral composition in the plane P-P.

As shown in FIG. 3, each of the control units 28 comprises a current regulator 50 which is connected individually to each of the LEDs 28 of the associated lighting module 16 by means of nine power supply lines 52. The current regulator 50 is connected to the electricity source 26 by a power supply line 54. An input 56 carried by the current regulator 50 enables the current passing through each of the LEDs 28 to be adjusted individually, thereby determining the level of light flux emitted by each of the LEDs 28.

The control unit 18 also comprises a calculation unit 58 which may be constituted, for example, by a microcontroller, having a color and intensity input 60 for receiving reference color and intensity values for the light to be emitted by the lighting module 16. An output 62 from the calculation unit 58 is connected to an input 56 of the current regulator 50 by a connecting line. The calculation unit 58 is adapted to respond to reference values to calculate a reference current for each of the LEDs 28 of the lighting module 16 and to apply the values of these currents individually to the current regulator 50.

The input 60 is connected by a connecting line 66 to the central unit 22. Each of the control units 18 is thus adapted to adjust the light flux in the light emitted by the nine LEDs 28 of the associated lighting module as a function of data emitted by the central unit 22.

The lighting element 14 also includes means 70 for detecting a fault, adapted to detect a defective LED 28 in the associated lighting module 16. These means 70 are constituted, for example, by a block 72 of current sensors adapted to detect the current that actually passes through each of the LEDs 28 and connected to an input 74 of the calculation unit 28 via a connecting line 76.

The calculation unit 58 also has an output 78 connected to the central unit by a connecting line 80.

The central unit 22 is constituted by a computer comprising a processor 82 and a memory 84 storing software for operating the lighting installation 2, together with operating parameters. The computer is connected to display means 86 in the form of a screen, and data input means 88, e.g. in the form of a keyboard.

The input means 88 enable a user to input reference values representing the overall color of the lighting light and the overall intensity of the light, or representing the temperature of the color.

The means 24 for detecting an obstacle comprise a charge-coupled device (CCD) camera 90 which is connected to the computer via a connecting line 92. In a variant, any other means for detecting the presence of an obstacle could be used, for example a proximity detector. The field of view of the CCD camera 90 is directed towards the lighted field 4 and it enables an image thereof to be picked up. The connecting line 92 is adapted to transmit the image as picked up to the computer.

The installation of the invention operates as follows.

Initially, the user uses the keyboard to key in values representative of the desired color and intensity for the light. These values are stored in the memory 84 by the processor 82 as an overall reference value for intensity an overall reference value for color.

When no obstacle is to be found in the lighting volume 40, individual reference values are transmitted to each of the control units 18 without modification. In other words, each of the lighting elements 14 receives the same reference values for color temperature, intensity, and relative intensity distribution for each of the LEDs 28.

The color and intensity reference values are then converted by the calculation unit 58 into current values for each of the LEDs 28.

Given that the reference values are identical for each of the lighting elements 14, each of these elements 14 emits identical light flux. The lighted field 14 is thus lighted uniformly.

The image picked up by the CCD camera 90 then presents intensity that is substantially uniform.

If a proximity detector is used instead of the CCD camera, then the detector evaluates the area of the obstacle.

When an obstacle, such as the head of a doctor 6, enters into the overlap volume 42 of one of the lighting modules 16, that leads to a shadow zone 38 in the lighted field 4, which degrades the quality of lighting.

The image picked up by the CCD camera 90 therefore decreases in intensity in the zone that corresponds to the shadow zone 38. The central unit 28 evaluates the image picked up by the CCD camera 90 and observes this decrease in intensity. Therefore, the central unit determines which modules 16 are contributing to lighting the overlap zone 32 in which the shadow zone 38 is situated, and also which lighting module 16 has the obstacle situated in its lighting volume 40.

For this purpose, the image picked up by the CCD camera 90 is subdivided into a multitude of image elements, each of which corresponds to a lighting module 16.

Once an obstacle has been observed, the central unit 22 progressively increases the intensity reference value for the lighting modules which contribute to lighting the overlap zone 32 that has become darker, with the exception of the lighting modules 16 having the obstacle situated in their lighting volumes 40. This increase is continued until the light flux is sufficient for the light intensity in the shadow zone 32 to have reached a value corresponding to the intensity which matches the reference value for intensity.

In a variant, the intensity reference value is increased by a determined ratio, this determined ratio being equal to the ratio of the area of the shadow zone 38 to the area of the overlap zone 32.

The light intensity in the shadow zone is thus increased and visibility is improved.

When one of the LEDs 28 of a lighting module 16 is defective, the control unit 18 observes this defect by means of the sensor 72 and it increases the current carried by the other LEDs 28 having the same color in the same module, so as to compensate for the decrease in light flux of that color being emitted by the lighting module 16.

In a variant, the control unit 18 decreases the light intensity emitted by the LEDs 28 that are of a color other than the color of the defective LEDs 28, so that the color of the light emitted by the module corresponds to the reference color. Thus, disturbances in lighting due to a local modification to the lighting color are avoided.

In a variant, the central unit 22 also decreases the intensity reference value for the lighting element 14 having the obstacle situated in its overlap volume 42. This reduces the energy consumption of the installation.

In a variant that is not shown, two lighting modules 16 which are adapted to light a common overlap zone 32 are separated from each other by at least one lighting module 16 adapted to light another overlap zone 32. Thus, the two modules 16 are spaced apart in such a manner that their lighting volumes 32 overlap to a small extent only. An obstacle coming into the overlap volume 42 of one of the lighting modules 16 thus penetrates little into the lighting volume 40 of the other lighting module 16. This other module 16 is thus better placed to maintain lighting in the overlap zone 32.

What is claimed is:

1. A lighting device for lighting a lighted field, in particular an operative field for a doctor, the device being of the type comprising a light source with first and second lighting modules, the lighting modules being adapted to light respective first and second lighted domains of the lighted field, said lighted domains overlapping at least in part so as to form an overlap zone, and each lighting module defining an overlap volume extending between the overlap zone and the surface of the light-emitting module that emits light towards the overlap zone,
the device including:
detector means adapted to detect a zone of reduced lighting in the overlap zone; and
control means adapted to increase the light flux from said second lighting module when the detector means detect a zone of reduced lighting.

2. A lighting device according to claim 1, wherein the light source is adapted to light the overlap zone with a determined level of lightning, and wherein the control means are adapted to increase the light flux from said second lighting module in such a manner that the level of lighting in the overlap zone is equal to the determined level.

3. A lighting device according to claim 1, wherein the detector means are adapted to detect a shadow zone which is created by an obstacle in the overlap volume of said first-lighting module and which is situated at least in part within the overlap zone, wherein the control means are adapted to increase the light flux from said second lighting module by a determined ratio, and wherein the determined ratio is equal to the ratio of the area of the shadow zone to the area of the overlap zone.

4. A lighting device according to claim 1, wherein the control means comprise means for decreasing light, and adapted to decrease the light flux from said first lighting module when said detector means detect a zone of reduced lighting.

5. A lighting device according to claim 1, wherein said first and second lighting modules are each adapted to emit light having identical spectral composition.

6. A lighting device according to claim 1, wherein at least one of the lighting modules comprises a light-emitting diode.

7. A lighting device according to claim 6, wherein at least one of the lighting modules comprises a plurality of light-emitting diodes with at least two of the light-emitting diodes being adapted to emit light of different colors, and wherein the control means comprise a control unit associated with each lighting module, said control unit being adapted to adjust the individual light flux level emitted by each of the light-emitting diodes of the lighting module as a function of a given reference value representing a color and an intensity.

8. A lighting device according to claim 7, wherein the light source comprises a plurality of lighting modules each comprising a plurality of light-emitting diodes, wherein the control means comprise a central unit adapted to generate individual reference values representing a color and an intensity of light for each of the lighting modules, and wherein each control unit is connected to the central unit so as to be able to receive the reference values for color and intensity.

9. A lighting device according to claim 8, wherein at least one lighting module comprises detector means for detecting a defective light-emitting diode, and wherein the device further comprises means for compensating the defect of a defective light-emitting diode.

10. A lighting device according to claim 9, wherein the compensation means comprise means adapted to decrease the light flux from the light-emitting diode emitting light of a color other than the color of the defective light-emitting diode.

11. A lighting device according to claim 9, wherein the lighting module comprises at least one other light-emitting diode of a color identical to that of the defective light-emitting diode, and wherein the compensation means are adapted to increase the light flux from the light-emitting diode having the same color as the defective light-emitting diode.

12. A lighting device according to claim 1, wherein the color rendering index of the light source is at least 90.

13. The use of a lighting device according to claim 1 to light a field of intervention of a doctor.
